(19) United States
(12) Patent Application Publication
(10) Pub. No.: US 2025/0191391 A1
(43) Pub. Date: Jun. 12, 2025

(54) PROCESSING MEDICAL IMAGES BASED ON MACHINE LEARNING MODELS

(71) Applicant: Shanghai United Imaging Intellgence Co., Ltd., Shanghai (CN)

(72) Inventors: Zhang Chen, Brookline, MA (US); Xiao Chen, Lexington, MA (US); Yikang Liu, Cambridge, MA (US); Lin Zhao, Billerica, MA (US); Shanhui Sun, Lexington, MA (US); Terrence Chen, Lexington, MA (US)

(73) Assignee: Shanghai United Imaging Intellgence Co., Ltd., Shanghai (CN)

(21) Appl. No.: 18/531,536

(22) Filed: Dec. 6, 2023

(51) Int. Cl. G06V 20/70; G06V 10/74; G06V 10/764; G06V 10/774

(52) U.S. Cl. CPC G06V 20/70; G06V 10/761; G06V 10/764; G06V 10/774; G06V 2201/03

(57) ABSTRACT

Described herein are systems, methods, and instrumentalities associated with medical image classification and/or sorting. An apparatus may obtain a medical image from a medical image repository and further obtain multiple textual descriptions associated with a set of image classification labels. The apparatus may pair the medical image with one or more of the multiple text descriptions to obtain one or more corresponding image-text pairs, and classify the medical image based on a machine learning (ML) model and the one or more image-text pairs. The ML model may be configured to predict respective similarities between the medical image and the corresponding text descriptions in the one or more image-text pairs, and the apparatus may determine the class of the medical image by comparing the similarities predicted by the ML model. The apparatus may then further process the medical image based on the class of the medical image.

### BACKGROUND

Healthcare organizations (e.g., hospitals) usually store patient medical images (e.g., scan images) in a centralized repository such as a picture archiving and communication system (PACS), and applications deployed to process those medical images may retrieve and sort the images based on their associated imaging modalities (e.g., MRI, CT, X-Ray, etc.), body parts (e.g., brain, knee, heart, etc.), and/or views (e.g., long axis view, short axis view, etc.). Conventional image sorting techniques use metadata stored together with the images to decide their types. For example, images stored in the Digital Imaging and Communications in Medicine (DICOM) format include header information that can be used to determine the imaging modality, body part, and/or view of each image. Such header information, however, is often manually generated and contains noise (e.g., typos and/or other types of human errors), which may lead to inaccurate sorting results. Furthermore, the information stored in the DICOM headers may include free texts, which are difficult and slow to process using rule-based techniques. Accordingly, systems and methods capable of sorting medical images quickly and accurately are desirable.

In related medical settings, image-based device tagging and tracking may be needed to determine the position of a medical device (e.g., stent, catheter, etc.) or an anatomical structure (e.g., a blood vessel) and its spatial relationship with other devices or anatomical structures. Machine learning (ML) models may be trained to accomplish such tasks, but conventional ML models focus only on image features and are limited by what images were used to train the ML models. Therefore, the conventional ML models cannot take advantage of additional, non-image based information (e.g., such as semantic information regarding a medical device) that may be available to the models to improve the accuracy of the predictions made by the models. The conventional ML models also lack the versatility to recognize medical devices that the models may not have been seen or been trained to handle during their training, and, as such, the ML models may be limited to what medical devices or anatomical structures they can process in real-time applications.

### SUMMARY

Described herein are machine learning (ML) based on systems, methods, and instrumentalities associated with medical image classification and/or sorting (e.g., including tagging and tracking an object in medical images). According to embodiments of the present disclosure, an apparatus may obtain a medical image from a medical image repository and further obtain multiple textual descriptions associated with a set of image classification labels (e.g., including object labels such as bounding boxes, semantic masks, etc.). The apparatus may pair the medical image with one or more of the multiple text descriptions to obtain one or more corresponding image-text pairs, and classify the medical image (e.g., including a patch or a group of pixels in the medical image) based on a machine-learning (ML) model and the one or more image-text pairs, wherein the ML model may be configured to predict respective similarities between the medical image and the corresponding text descriptions in the one or more image-text pairs, and wherein the apparatus may determine the class of the medical image by comparing the similarities predicted by the ML model. The apparatus may then further process the medical image based on the class of the medical image (e.g., by providing the medical image to a medical image processing application or module configured to process medical images of the same class).

In examples, the ML model may include a vision encoding portion (e.g., a vision encoder) and a text encoding portion (e.g., a text encoder). The vision encoding portion may be configured to encode image features of the medical image, the text encoding portion may be configured to encode respective text features of the multiple textual descriptions, and the ML model may be configured to predict the respective similarity between the medical image and the corresponding text description in each of the one or more image-text pairs based on the image features of the medical image and the text features of the corresponding text description in each of the one or more image-text pairs. For instance, the ML model may be configured to align the image features of the medical image with the respective text features of the corresponding text description in each of the one or more image-text pairs in a common embedding space, and the apparatus may determine the class of the medical image based on an image-text pair of which the textual description is predicted by the ML model to be most similar to the medical image (e.g., the image and text features are close to each other in the common embedding space).

In examples, the text description of the image-text pair that is predicted by the ML model to be most similar to the medical image may be generated based on one of the image classification labels, and the apparatus may determine the class of the medical image based on the image classification label from which the text description is generated. In examples, the set of image classification labels may identify multiple body parts, multiple imaging modalities, multiple image views, or multiple imaging protocols. Further, at least one of the textual descriptions may include a negation of an association between the medical image and one of the image classification labels.

In examples, the ML model may be trained using a training dataset comprising multiple training image-text pairs, wherein each training image-text pair may include a training image and a training textual description, and the ML model may be trained to learn a similarity or dissimilarity between the training image and the training textual description in each training image-text pair based on a contrastive learning technique. In examples, the class of the medical image may or may not be present in the training dataset.

In examples, the textual descriptions described herein may include a prompt (e.g., natural language based prompt) to tag and/or track a structure (e.g., a stent, a catheter, etc.) in the medical image and the apparatus being configured to classify the medical image may include the apparatus being configured to tag and/or track the structure in the medical image using a vision-language model trained for matching features of the prompt with features of the structure as depicted in the medical image.

### BRIEF DESCRIPTION OF THE DRAWINGS

A more detailed understanding of the examples disclosed herein may be had from the following description, given by way of example in conjunction with the accompanying drawing.

FIG. 1 is a simplified block diagram illustrating an example of sorting medical images based on an ML model.

FIG. 2 is a simplified diagram illustrating an example of automatically tagging and/or tracking a structure in one or more medical images based on an ML model.

FIG. 3 is a simplified block diagram illustrating an example of training an ML model for extracting features from paired images and textual descriptions and for predicting the similarity of the image and text description in each image-text pair.

FIG. 4 is a simplified diagram illustrating an example of augmenting a dataset used to train an ML model for tagging and tracking a structure in one or more medical images.

FIG. 5 is a simplified block diagram illustrating an example of performing an image classification (e.g., image sorting) task based on an ML model.

FIG. 6 is a diagram illustrating an example of sorting medical images for the purpose of further processing them using an appropriate program or module.

FIG. 7 is a diagram illustrating an example of tagging and/or tracking a structure in one or more medical images using an ML model.

FIG. 8 is a flow diagram illustrating example operations that may be associated with training an artificial neural network to learn the ML model described herein.

FIG. 9 is a block diagram illustrating example components of an apparatus that may be configured to perform the tasks described herein.

### DETAILED DESCRIPTION

The present disclosure is illustrated by way of example, and not by way of limitation, in the figures of the accompanying drawings. A detailed description of illustrative embodiments will be provided with reference to the figures. Although these embodiments may be described with certain technical details, it should be noted that the details are not intended to limit the scope of the disclosure. Further, while some embodiments may be described in a medical setting, those skilled in the art will understand that the techniques disclosed in those embodiments may be applicable to other settings or use cases as well.

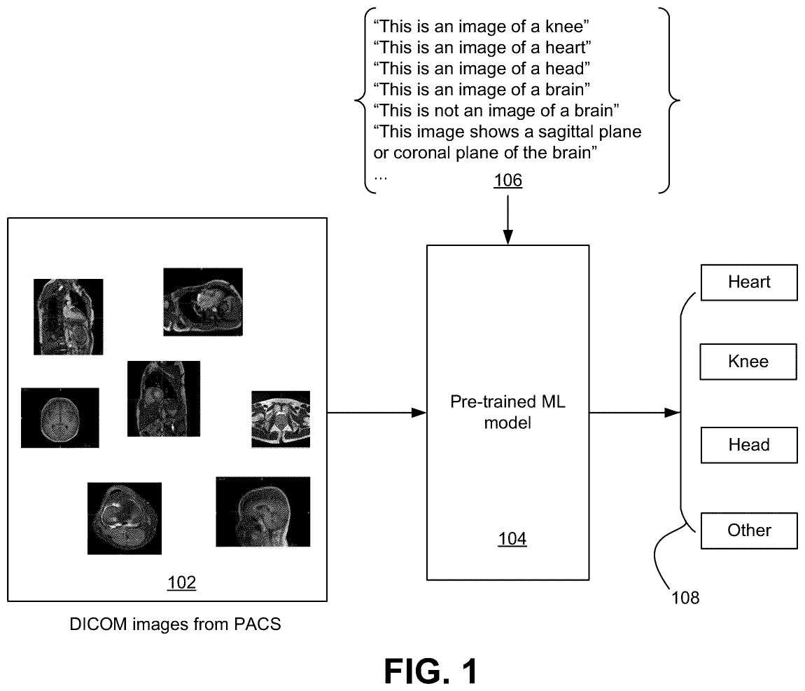

FIG. 1 illustrates an example of sorting medical images 102 using a machine-learning (ML) model 104 in accordance with embodiments of the present disclosure. In this disclosure, the term “machine-learning model” may be used interchangeably with the term “machine-learned model,” “artificial intelligence (AI) model,” “artificial neural network,” or “neural network.” Further, even though the term “model” may be used in a singular form, those skilled in the art will understand that the functionalities described herein as being realized via an ML “model” may also be realized using multiple ML models, with each model configured to implement a subset or portion of the functionalities.

As shown in FIG. 1, the medical images 102 may include various scan images that may be stored in the Digital Imaging and Communications in Medicine (DICOM) format and/or in a medical image repository such as a picture archiving and communication system (PACS). These scan images may be captured using different imaging modalities and may depict different parts of the human body. For example, the scan images may include magnetic resonance imaging (MRI) images, computed tomography (CT) images, and/or X-Ray images, while the body parts depicted in the images may include a heart, a head/brain, a chest, a knee, etc. In examples, the scan images may also represent different views of a body part. For instance, while some of the scan images may provide 2-chamber views of a heart, others may provide 3-chamber or 4-chamber views of the heart.

To process the medical images 102 using a complex software package including multiple modules, the images may need to be sorted so that they can be assigned to an appropriate module (e.g., a brain MRI processing module, a brain CT processing module, a chest X-Ray processing module, a mammogram image processing module, etc.). As described herein, the sorting may be performed based on metadata information associated with the medical images 102 and/or using one or more rule-based techniques (e.g., keyword matching). But since the metadata may be noisy (e.g., containing typos and/or other types of human errors) and/or include free texts, sorting the medical images 102 based on such data and using the conventional techniques may lead to inaccurate results.

The ML model 104 may be used to resolve the issues associated with conventional image sorting. In examples, the ML model 104 may be trained (e.g., pretrained) as an image classifier, but different from a traditional image classifier that may be trained using labeled images and may only be able to classify images of a fixed set of categories (e.g., the categories included in training data), the ML model 104 may be trained using paired images and textual descriptions, and may be capable of classifying images that belong to a class not present in the training data. The image-text pairs used to train the ML model 104 may be obtained from the Internet (e.g., medical websites that may include medical images and corresponding descriptions), publicly accessible databases (e.g., figures and captions from repositories of academia publications), hospital records or medical reports (e.g., radiology reports), etc. As will be described in greater detail below, the ML model 104 may be configured to extract respective features from paired images and textual descriptions, and, through the training, may acquire the ability to align the extracted image features and text features into a common embedding space (e.g., based on the semantic meanings of the features), and recognize the image-text pair of which the image features are most similar to the text features. The class of the image in this image-text pair may then be determined based on the corresponding text description, which may be designed to reflect a classification label.

As shown in FIG. 1, given a medical image 102 that may be retrieved from an image repository and classified into one of a set of classes, multiple textual descriptions 106 may be devised based on classification labels (e.g., knee, heart, head, etc.) associated with the set of classes. The set of classes may be determined based on the specific requirements of an application scenario (e.g., based on imaging modalities, body parts, views, etc.) and may include classes that were not presented in the data used to train the ML model 104. The textual descriptions 106 may take a variety of forms (e.g., including natural language forms) to enhance the robustness of the ML model 104. For example, the textual descriptions 106 may include affirmative statements such as “this is an image of a knee,” “this is an image of a heart,” and/or “this is an image of a head.” The textual descriptions 106 may also include a negation of an association between the medical image 102 and one of the classification labels, such as, e.g., “this is not an image of the brain.” As will be described in greater detail below, the inclusion of negative terms in the textual descriptions 106 may help exclude certain classes from a final prediction and complement the predictions made based on positive terms (e.g., the positive and negative terms may work in conjunction to narrow down prediction results from opposite directions). The textual descriptions 106 may also include multiple descriptions for the same class, such as, e.g., “this is an image of a brain” and “this is an image of a head.” The textual descriptions 106 may also include multiple descriptive terms associated with a class, such as, e.g., “this image shows the sagittal plane or coronal plane of a brain.”

Once derived, the text descriptions 106 (e.g., a subset or all of the textual descriptions 106) may be paired with the medical image 102 to obtain one or more corresponding image-text pairs. The class of the medical image 102 may then be determined by predicting, using the ML model 104 and based on text and image features extracted from each image-text pair, the similarity between the medical image and the corresponding text description in the image-text pair. The respective similarities of the image-text pairs may be compared to identify the pair of which the textual description is deemed most similar to the medical image 102, and the class of the medical image 102 may be determined based on the text description (e.g., since the text description may be created based on a classification label 108 and may thus be linked to the classification label). The class determined using the techniques described herein may be used to facilitate further processing of the medical image 102. For example, the class may be used to group the medical image 102 with one or more other medical images having the same class and/or to select an application program or module to which the medical image 102 may be provided. Such an application program or module may be designed for a specific purpose (e.g., to process brain MRIs, brain CTs, or cardiac MRIs, to determine late gadolinium enhancements (LGE), T1 maps, or T2 maps, etc.) and, as such, may only accept images of a certain type or class.

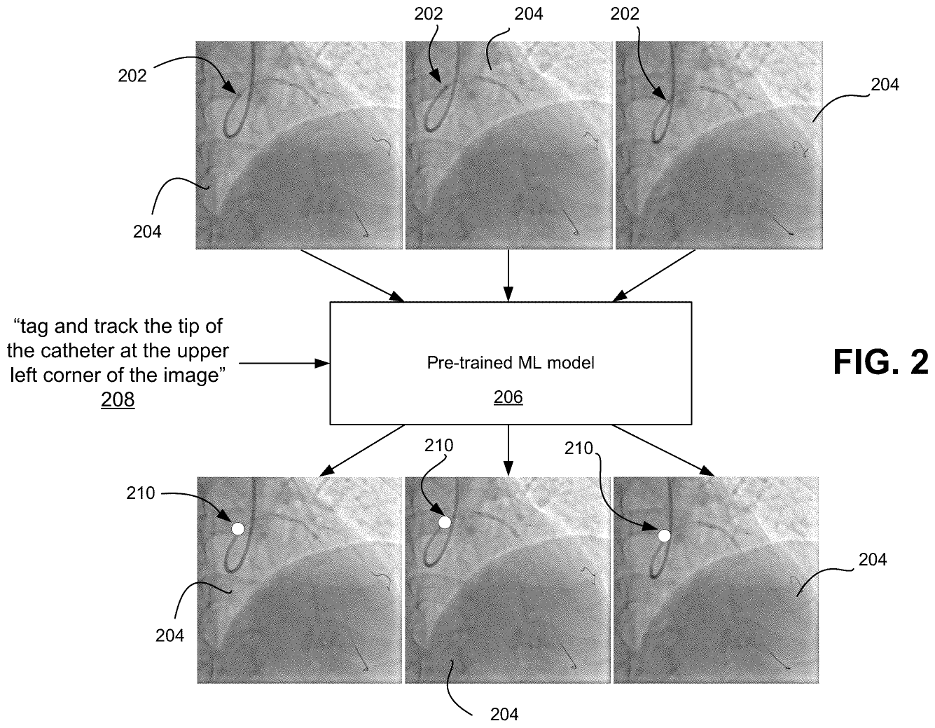

FIG. 2 illustrates an example of automatically tagging (e.g., segmenting or otherwise marking) and/or tracking a structure 202 in one or more medical images 204 (e.g., X-Ray fluoroscopy images or movies) using a machine-learning (ML) model 206. The structure 202 may be a medical device, such as, e.g., a stent or a catheter placed into a patient's body, or an anatomical structure of the patient, such as, e.g., a blood vessel. The tagging and/or tracking may be performed based on a language prompt 208 that may be provided in the form of a description, a request, or a command (e.g., such as “tag and track the tip of the catheter at the upper left corner of the image”). The language prompt 208 may be received in real-time, for example, as the medical images 204 are displayed on a computer screen, and provided using a text entry device (e.g., a keyboard) or as a voice prompt (e.g., by a physician investigating the medical images 204). The tagging and/or tracking may also be performed in real-time and may produce indications of the position of the structure in each medical image 204, for example, via a heatmap that reflects the area of each medical image 204 containing the structure 202 (e.g., the heatmap may mark the tip 210 of the structure 202 in each medical image 204). The results of the tagging and/or tracking may be used for various purposes, such as, e.g., determining the spatial relationship of the structure 202 with other structures during interventional radiology (IR).

Compared to conventional object tracking models that may rely entirely on image features associated with the target object and only be able to recognize objects that the models have seen during their training, the ML model 206 may be a vision-language based model trained using paired images and language prompts (e.g., textual descriptions or voice prompts) to learn the correlations (or similarities) between image and text features in a common embedding space and thus capable of tracking an object (e.g., structure 202) with improved accuracy, even if the object may not have been present in the dataset used to train the ML model 206. The accuracy of the tagging and/or tracking may improve because the ML model 206 may utilize information provided by the language prompt 208 in addition to information provided by the medical image 204 for the tagging and/or tracking. For instance, the ML model 206 may match a language prompt such as “tag and track the tip of the catheter at the upper left corner, which is a dark and bent tube” to corresponding image features based on not only the indicated location of the image features (e.g., the upper right corner of the image) but also the indicated color and shape of the image features (e.g., dark and bent). Further, the ML model 206 may be capable of recognizing objects that it may not have encountered in the past because the tagging may be performed based on knowledge about the distance of text and image features that the ML model has acquired through training rather than a strict match between known image features of the structure 202 and the actual image features extracted from the medical image 204.

Similar to the ML model 104 shown in FIG. 1, the image-text pairs used to train the ML model 206 may be obtained from the Internet (e.g., medical websites that may include medical images and corresponding descriptions), publicly accessible databases (e.g., figures and captions from repositories of academia publications), hospital records or medical reports (e.g., radiology images, videos, reports), etc. As will be described in greater detail below, the ML model 206 may be trained to extract respective features from the paired images and textual descriptions, align the extracted image features and text features into a common embedding space, and identify image features in the common embedding space that correspond to the features of a given language prompt.

This should note that the ML model 206 may include more than a vision-language based model trained for tagging (e.g., segmenting) the structure 202 in medical images 204. For instance, when language prompt 208 is a voice prompt, the ML model 206 may further include a voice recognition model (e.g., a sub-component of the ML model 206) trained for converting the voice prompt into a textual prompt, which may then be processed by the vision-language model. It should also be noted that object/structure tagging and tracking may be dealt with as an imaging classification problem in the sense that the tagging and tracking may involve classifying certain image patches or image pixels as belonging or not belonging to the object/structure. As such, the techniques described herein for image classification (e.g., in association with FIG. 1) may also be applicable to object tagging and/or tracking in medical images.

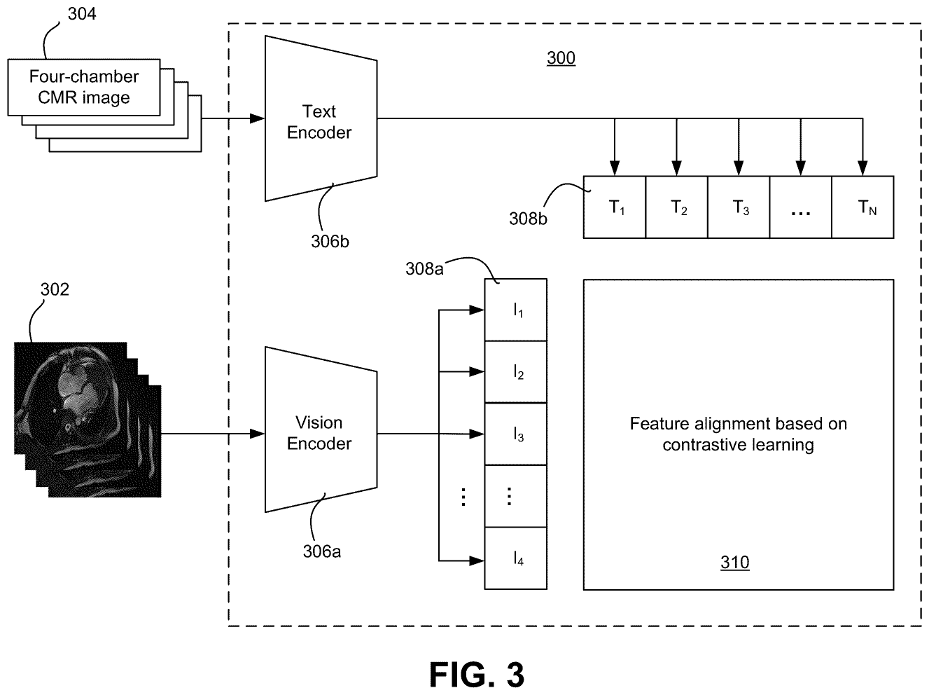

FIG. 3 illustrates an example of training an ML model 300 (e.g., part of the ML model 104 of FIG. 1 or ML model 206 of FIG. 2) for extracting features from paired images and textual descriptions and determining the similarity of the image and text description in each image-text pair (e.g., to determine which image-text pair includes the most similar image and textual description). As explained above, unlike traditional ML models that may process text and images separately, ML model 300 may be trained to compare and contrast text and images using a unified framework (e.g., using a vision-language ML model). The training of the ML model 300 may be conducted using a large dataset that may include medical images 302 and corresponding textual descriptions 304. Such training data may be obtained from various sources including, for example, the Internet (e.g., medical websites that may include medical images and corresponding textual descriptions that describe the content of the images), publicly accessible databases (e.g., figures and captions from repositories of academia publications), hospital records or medical reports (e.g., radiology reports), etc. The training data may be pre-processed, for example, to ensure that it is in a suitable format for the training. The pre-processing may involve resizing the images, tokenizing the text, creating pairs of image-text inputs, etc. The pre-processing may also include augmenting the training data (e.g., such as by adding textual descriptions comprising negative terms to the training dataset) to improve the robustness and accuracy of the ML model 300.

As shown in FIG. 3, ML model 300 may include a vision or image encoding portion (e.g., a vision/image encoder 306a) and a text encoding portion (e.g., a text encoder 306b). In examples, the vision encoder 306a may be implemented using a vision transformer architecture designed to extract image features 308a from the input images 302, while the text encoder 306b may be implemented using a regular transformer architecture designed to extract text features 308b from the textual descriptions 304. In examples, the vision encoder 306a and the text encoder 306b may be trained first (e.g., separately) on a large number of images and textual descriptions, respectively, and a contrastive learning technique may then be employed to force the ML model 300 to bring similar image-text pairs closer in a common/shared embedding space 310 while pushing dissimilar pairs apart. Various contrastive loss functions including normalized temperature-scaled cross-entropy (NT-Xent) or information noise-contrastive estimation (InfoNCE) loss may be used to optimize the parameters of the ML model 300. In examples, the ML model 300 may be further fine-tuned, for example, using an application specific dataset (e.g., a certain type of medical scan images, fluoroscopy videos, voice prompts, heatmaps, etc.) and/or based on a specific downstream task (e.g., medical image classification, object detection, object tagging and/or tracking, image-text retrieval, etc.).

The training (e.g., pretraining) may help the ML model 300 acquire an understanding of the relationships between visual and textual features such that when given a text prompt (e.g., a textual description) and an image as inputs, the ML model 300 may produce an indication (e.g., a similarity score) of how well the two inputs match. For example, given a text prompt such as “an MRI image of the brain” and MRI images of different body parts (e.g., brain, heart, knees, etc.), the ML model 300 may rank the brain MRI images higher than the knee or heart MRI images since the ML model 300 has learned, through the training, the correlation between brain MRI images and textual descriptions containing the term “brain” (or other similar terms). The ML model 300 may also acquire the ability to perform zero-shot classification from the training (e.g., the ML model 300 may recognize images or texts that it has not seen during the training). For instance, given the ML model 300 an MRI image of a knee that the model has never encountered before and a textual description such as “a knee MRI,” the ML model can still identify the image as an MRI image of the knee (e.g., because the ML model has the ability to determine that the text “a knee MRI” matches the best with the input knee MRI image).

As described with respect to FIG. 2, the ML model 300 may also be used to automatically tag and/or track a structure (e.g., a stent, a catheter, a blood vessel, etc.) in a medical image (e.g., an X-Ray fluoroscopy image) based on a language prompt (e.g., such as “track the tip of the catheter at the upper left corner of the image”). The ML model 300 may be able to perform the tagging and/or tracking based on an understanding of correlated visual and textual features that the ML model 300 may have acquired through the training process described above. For instance, the ML model 300 may have learned what image features in the common embedding space described herein correspond to text features associated with a language prompt and subsequently be able to identify those image features and the image area that contains those image features based on the language prompt (e.g., so as to tag the image area as containing the structure indicated by the language prompt).

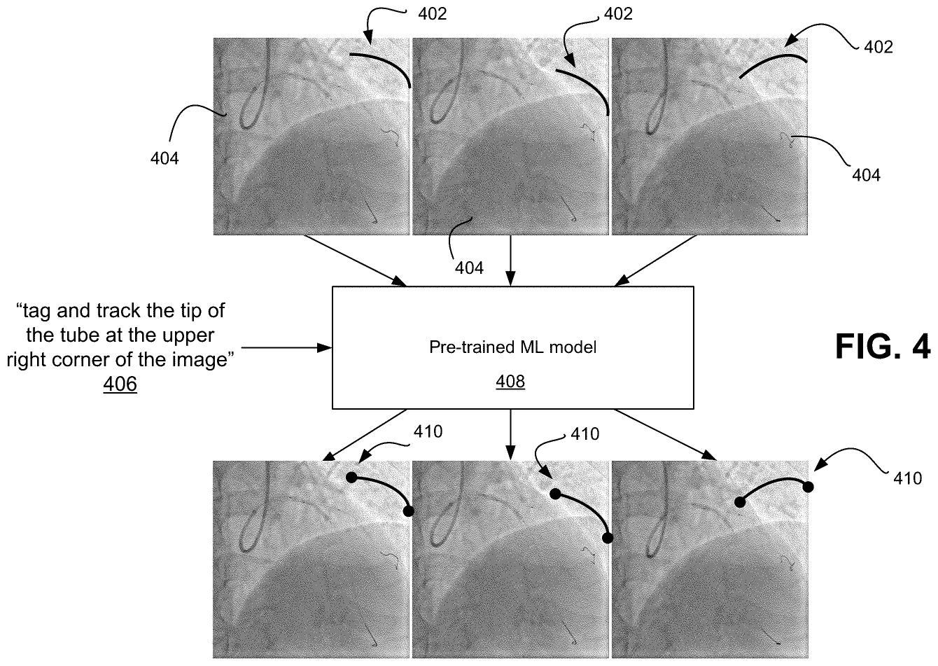

When trained to perform the image sorting task described herein, the accuracy of the ML model 300 may be improved using augmented training data that may include negative terms in a textual description (“this image is not a brain MRI image”), multiple terms in a textual description (“this image shows a sagittal plane or a coronal plane of a brain”), etc. Training the ML model 300 with such augmented data may expose the ML model to more varieties of descriptions and/or help the ML model exclude certain candidates from its predictions. For instance, by including negative terms in a textual description such as “this image is not a brain MRI image” and pairing the textual description with a knee MRI image, the ML model may learn to exclude “brain” as a potential class when attempting to classify a knee MRI image. When trained to perform the image tagging task described herein, the accuracy of the ML model 300 may be improved using synthesized training data that may compensate for the lack of real training data. FIG. 4 shows an example in which an artificially created tube-like object 402 is placed in the upper right corner of one or more training images 404, before the augmented training images 404 are used with a prompt 406 (e.g., “track the tip of the tube at the upper right corner”) and corresponding ground truth (e.g., heatmaps) to train the ML model 408 (e.g., the ML model 206 of FIG. 2 or ML model 300 of FIG. 3) for tagging the structure 402 in each medical image 404 (e.g., via end-point markers 410).

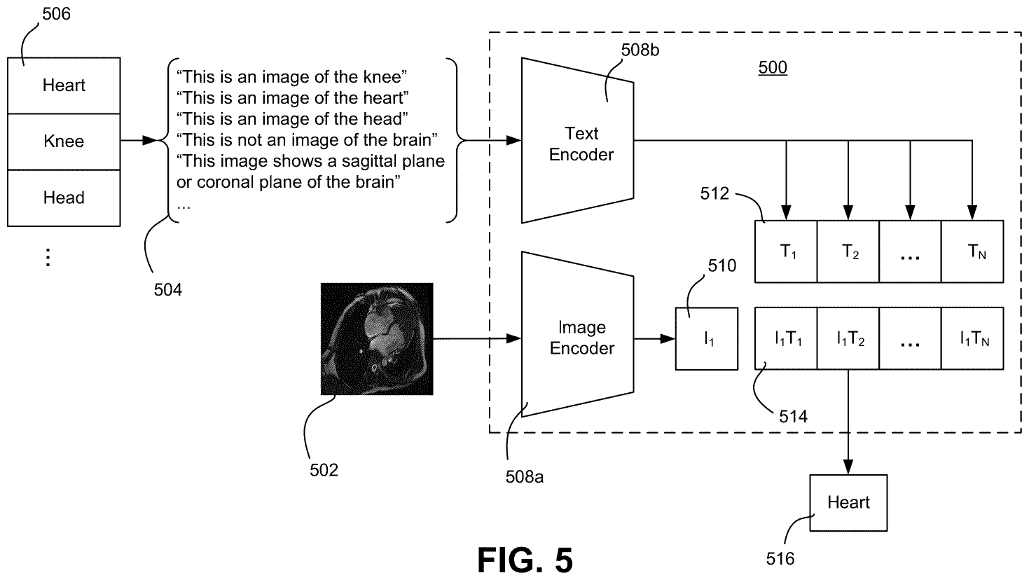

FIG. 5 illustrates an example of performing an image classification (e.g., image sorting) task based on the ML model (e.g., ML model 300 of FIG. 3) described herein. As shown in FIG. 5, an ML model 500 (e.g., the ML model 104 of FIG. 1 or ML model 300 of FIG. 3) may be tasked with classifying a medical image 502, for example, for purposes of determining which program or module of a software application suite may be invoked to process the medical image. To accomplish the task, multiple textual descriptions 504 may be created based on the task at hand. For instance, if the software application suite includes different programs or modules designed to process MRI images of different body parts (e.g., heart, knee, head, etc.), the textual descriptions 504 may be created based on a set of classification labels 506 (e.g., heart, knee, head, etc.) corresponding to the different body parts. The textual descriptions 506 may then be paired with the medical image 502 to derive multiple image-text pairs that may be provided to the ML model 500 as input. For each pair of image and text description, the ML model 500 may extract image and text features using the vision encoding 508a and text encoding 508b portions of the ML model, respectively. The ML model 500 may then align the image features 510 and text features 512 into a common embedding space 514 and further determine which image-text pair has the best matching image-text features. The ML model 500 may provide an indication of the matching, for example, by assigning a respective similarity score to each image-text pair. The pair with the highest score may then be selected as the best matching pair and the corresponding textual description may be used to determine the class of the medical image 502 (e.g., the class may be determined based on the classification label 516 that was used to create the best-matching textual description).

In examples, the textual descriptions 504 may include multiple prompts for one class. For example, for a class of brain images (e.g., with a classification label of “head”), the textual descriptions 504 may include the following prompts: “this is an image of a brain”, “this is an image of a head”, “this image shows a sagittal plane of a brain”, and “this image shows a coronal plane of a brain.” In this situation, the ML model 500 may classify the input image 502 as belonging to the “brain” class if the respective similarity scores between the input image 502 and each of the aforementioned prompts, in aggregate (e.g., based on an average), rank higher than other image-text pairs containing a textual description unrelated to the “brain.”

In examples, the ML model 500 may be trained to handle 2D images but may still be capable of processing 3D (or even higher dimensional) images after the training. This may be accomplished, for example, by dividing the 3D (or higher dimensional) images into 2D images (e.g., 2D slices) and running the ML model 500 on each 2D slice or a selected set of 2D slices (e.g., to speed up the computation). The prediction results obtained from these 2D slices may then be combined (e.g., based on averaging or majority voting) to determine a classification for the original image.

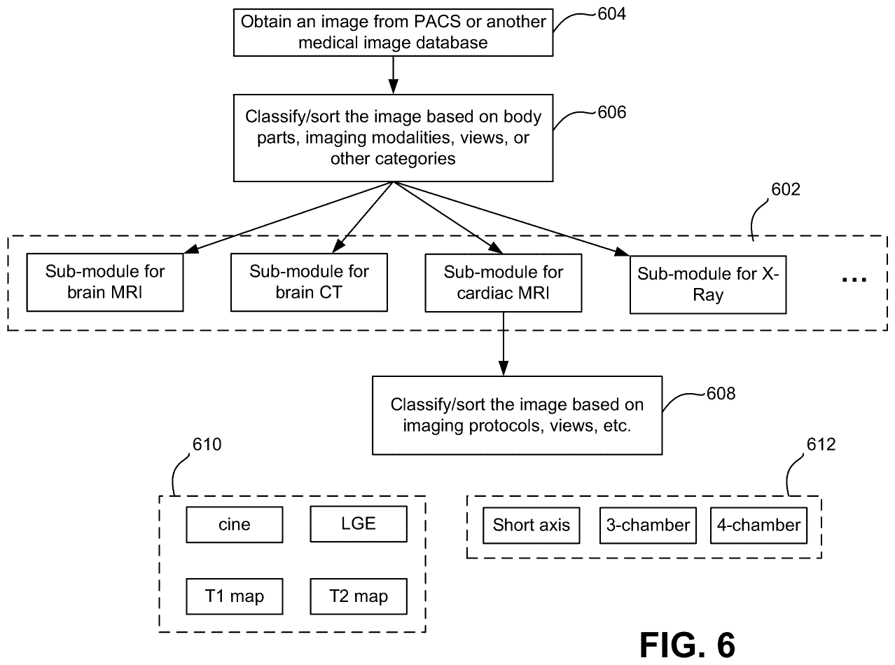

As explained earlier in this disclosure, classification and/or sorting of medical images may be performed for various purposes. FIG. 6 illustrates an example of sorting medical images for the purpose of further processing them using an appropriate program or module. As shown in FIG. 6, an image processing software package 602 may include multiple sub-modules, such as, e.g., a sub-module for brain MRI, a sub-module for brain CT, a sub-module for cardiac MRI, and/or a sub-module for X-Ray. Upon obtaining (e.g., retrieving) a medical image from an image database such as a PACS at 604, the software package 602 may classify (e.g., sort) at 606 the image into one or more of the categories that correspond to the sub-modules (e.g., according to imaging modalities or body parts). In addition, images that have already been classified or sorted may be grouped into additional categories or sub-categories, which may include those not seen during the training of the ML model. For example, as shown in FIG. 6, an image that has been classified as a cardiac MRI image may be further classified at 608 based on the imaging protocol 610 and/or view 612 associated with the image.

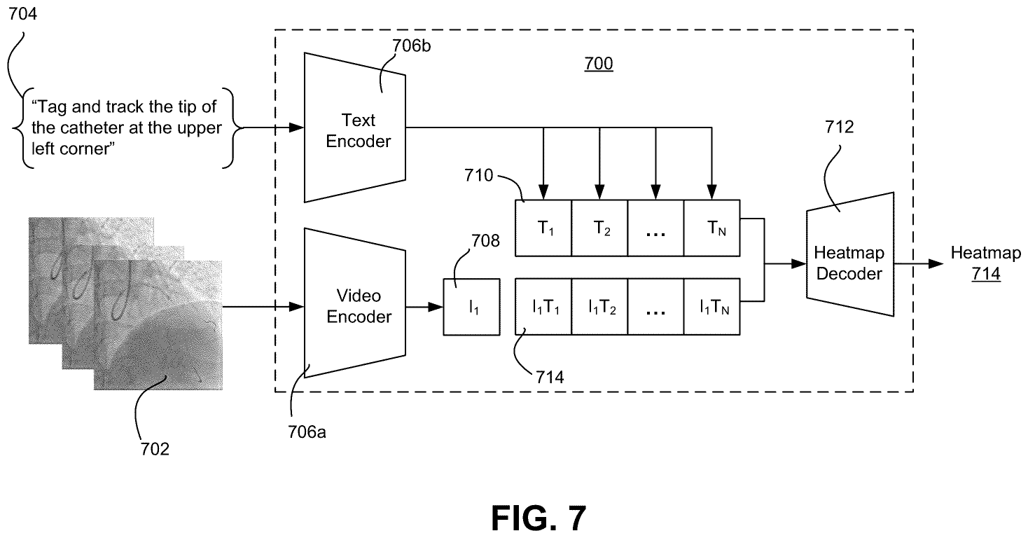

FIG. 7 illustrates an example of tagging and/or tracking a structure in one or more medical images 702 using an ML model 700 described herein (e.g., ML model 206 of FIG. 2). As shown in FIG. 7, the tagging may be performed based on a language prompt 704 (e.g., a voice prompt) such as, e.g., “tag and track the tip of the catheter at the upper left corner.” From the medical image 702 and the language prompt 704, the ML model 700 may extract image and text features using a video encoding module 706a and a text encoding module 706b, respectively. The ML model 700 may then align the image features 708 and text features 710 into a common embedding space 714 and further determine which subset of image features 708 match the best with text features 710. The ML model 700 may then provide the best matching features to a decoding module 712 (e.g., a heatmap decoding module of the ML model 700) to generate an indication (e.g., a heatmap 714) of where the target structure is located in the medical image 702.

Part of the ML model described herein (e.g., vision encoder 306a or text encoder 306b of FIG. 3, or video encoder 706a or text encoder 706b of FIG. 7) may be implemented using a vision transformer (ViT). The ViT may include multiple (e.g., two) components, such as, e.g., a feature extractor and a transformer encoder. The feature extractor may include a convolutional neural network (CNN) configured to extract features (e.g., local features) from an input image. The extracted features may be then flattened into a feature representation (e.g., such as a two-dimensional (2D) feature vector) and fed into the transformer encoder. The transformer encoder may include multiple layers, each of which may include a multi-head self-attention layer and/or a feedforward layer. The self-attention layer may allow the ViT to attend to different parts of the feature sequence and learn relationships between them, while the feedforward layer may apply a non-linear transformation to each feature vector. Residual connections and layer normalization may be applied after a sub-layer, for example, to stabilize the training of the VIT. Using such a ViT architecture, an entire image may be processed at once, for example, without spatial pooling. The output of the ViT may include a sequence of feature vectors, each of which may correspond to a different patch in the input image.

Part of the ML model described herein (e.g., vision encoder 306b or text encoder 306b of FIG. 3, or video encoder 706a or text encoder 706b of FIG. 7) may be implemented using a regular transformer architecture. The transformer may include an encoder and/or a decoder, each of which may include multiple layers. The encoder may be configured to receive a sequence of input tokens (e.g., the words in a textual description/prompt as described herein) and generate a sequence of hidden representations or embeddings that may capture the meaning of each token. An encoder layer may include multiple (e.g., two) sub-layers, such as, e.g., a multi-head self-attention layer and a position-wise feedforward layer. The self-attention layer may allow the transformer network to attend to different parts of the input sequence and learn the relationships between them. For example, via the self-attention layer, a weighted sum of the input tokens may be calculated, where the relevant weights may be determined through a learned attention function that accounts for the similarity between each token and all other tokens in the sequence. The feedforward layer may then apply a non-linear transformation to each token's hidden representation, allowing the neural network to capture complex patterns in the input sequence. Residual connections and/or layer normalization may be used and/or applied after each sub-layer to stabilize the training of the network. The decoder of the transformer architecture may be configured to receive a sequence of target tokens and generate a sequence of hidden representations (e.g., embeddings) that may capture the meaning of each target token, conditioned on the encoder's output. A decoder layer may also include multiple (e.g., two) sub-layers, such as, e.g., a masked multi-head self-attention layer, which may attend to target tokens that have already been generated, and a multi-head attention layer, which may attend to the encoder's output. The masked self-attention layer may allow the neural network to generate the target tokens one at a time, while preventing it from looking ahead in the sequence. The multi-head attention layer may attend to the encoder's output to help the neural network generate target tokens that may be semantically related to the input sequence. The decoder may also include a position-wise feedforward layer and may use or apply residual connections and/or layer normalization after each sub-layer (e.g., similar to the encoder).

In examples, the image features/embeddings and the text features/embeddings extracted from an image-text pair may be aligned in a common embedding space based on a cross-attention module. The alignment may be accomplished, for example, by exchanging the key, value, and/or query matrices of the respective transformer networks used to extract the image and text embeddings. For instance, the text embeddings may be provided to the cross-attention module in one or more key matrices and one or more value matrices, while the image embeddings may be provided to the cross-attention module in one or more query matrices. As a result, an output of the cross-attention module may include an aligned feature representation that corresponds to a conditioning of the image embeddings on the text embeddings (e.g., the cross-attention module may combine asymmetrically the image and text embeddings to fuse the information obtained cross two different modalities).

In examples, the ML model described herein may be trained using a contrastive learning technique, with which a contrastive loss function (e.g., a distance-based contrastive loss function or a cosine similarity based contrastive loss function) may be used to calculate a difference between the image features extracted from the image of an image-text pair and the text features extracted from the textual description in the image-text pair. The parameters of the ML model may then be adjusted (e.g., by backpropagating a gradient descent of the difference or loss through the relevant neural network) with an objective to minimize the difference when the image features are similar to the text features, and to maximize the difference when the image features are dissimilar to the text features.

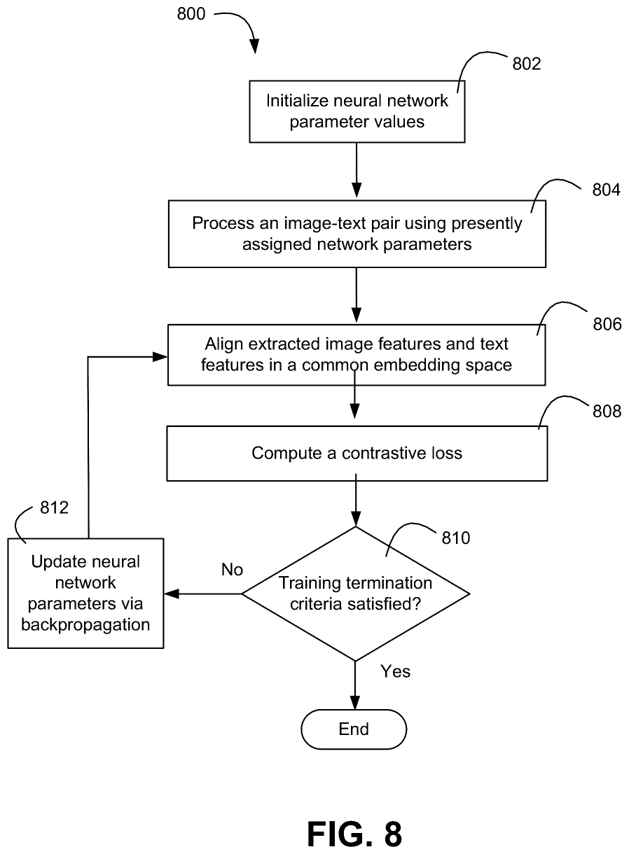

FIG. 8 illustrates example operations 800 that may be associated with training an artificial neural network to learn the ML model described herein. As shown, the training operations 800 may include initializing the operating parameters of the neural network (e.g., weights associated with various layers of the neural network) at 802, for example, by sampling from a probability distribution or by copying the parameters of another neural network having a similar structure. The training operations 800 may further include processing an image-text pair at 804 using presently assigned parameters of the neural network to align the respective image features and text features of the image-text pair in a common embedding space. The training operations 800 may further include calculating a contrastive loss at 808, for example, using a distance-based or cosine similarity based contrastive loss function, and determine, at 810, whether one or more training termination criteria are satisfied based on the loss. For example, the training termination criteria may be determined to be satisfied if the loss for a similar image-text pair is smaller than a threshold (e.g., indicating that the similar features are sufficiently close in the common embedding space) and/or if the loss for a dissimilar image-text pair is larger than a threshold (e.g., indicating that the dissimilar features are sufficiently apart in the common embedding space). If the determination at 810 is that the termination criteria are satisfied, the training may end; otherwise, the presently assigned network parameters may be adjusted at 812, for example, by backpropagating a gradient descent of the calculated loss through the neural network, before the training returns to 806.

For simplicity of explanation, the training operations 800 are depicted and described with a specific order. It should be appreciated, however, that the training operations 800 may occur in various orders, concurrently, and/or with other operations not presented or described herein. Furthermore, it should be noted that not all operations that may be included in the training method are depicted and described herein, and not all illustrated operations are required to be performed. Further, the neural network described herein may include an image encoder pretrained for image-only tasks and/or a text encoder pretrained for text-only tasks. In those situations, the weights of the image/text encoder may be adapted as initial weights for the neural network described with respective to FIG. 8 and may be partially freeze during the training process described above (e.g., not updated during the training process).

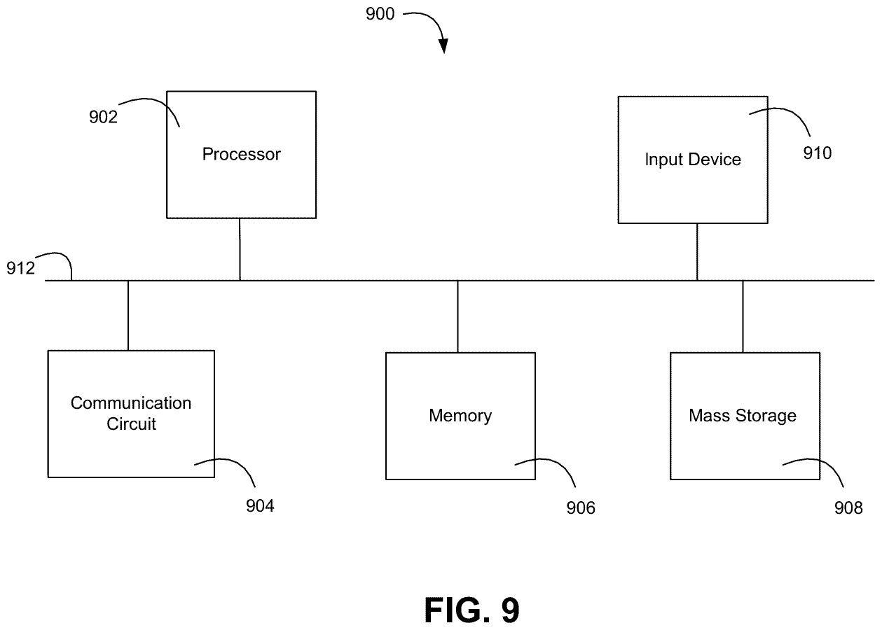

The systems, methods, and/or instrumentalities described herein may be implemented using one or more processors, one or more storage devices, and/or other suitable accessory devices such as display devices, communication devices, input/output devices, etc. FIG. 9 illustrates an example apparatus 900 that may be configured to perform the automatic image annotation tasks described herein. As shown, apparatus 900 may include a processor (e.g., one or more processors) 902, which may be a central processing unit (CPU), a graphics processing unit (GPU), a microcontroller, a reduced instruction set computer (RISC) processor, application specific integrated circuits (ASICs), an application-specific instruction-set processor (ASIP), a physics processing unit (PPU), a digital signal processor (DSP), a field programmable gate array (FPGA), or any other circuit or processor capable of executing the functions described herein. Apparatus 900 may further include a communication circuit 904, a memory 906, a mass storage device 908, an input device 910, and/or a communication link 912 (e.g., a communication bus) over which the one or more components shown in the figure may exchange information.

Communication circuit 904 may be configured to transmit and receive information utilizing one or more communication protocols (e.g., TCP/IP) and one or more communication networks including a local area network (LAN), a wide area network (WAN), the Internet, a wireless data network (e.g., a Wi-Fi, 3G, 4G/LTE, or 5G network). Memory 906 may include a storage medium (e.g., a non-transitory storage medium) configured to store machine-readable instructions that, when executed, cause processor 902 to perform one or more of the functions described herein. Examples of the machine-readable medium may include volatile or non-volatile memory including but not limited to semiconductor memory (e.g., electrically programmable read-only memory (EPROM), electrically erasable programmable read-only memory (EEPROM)), flash memory, and/or the like. Mass storage device 908 may include one or more magnetic disks such as one or more internal hard disks, one or more removable disks, one or more magneto-optical disks, one or more CD-ROM or DVD-ROM disks, etc., on which instructions and/or data may be stored to facilitate the operation of processor 902. Input device 910 may include a keyboard, a mouse, a voice-controlled input device, a touch sensitive input device (e.g., a touch screen), and/or the like for receiving user inputs to apparatus 900.

It should be noted that apparatus 900 may operate as a standalone device or may be connected (e.g., networked, or clustered) with other computation devices to perform the functions described herein. And even though only one instance of each component is shown in FIG. 9, a skilled person in the art will understand that apparatus 900 may include multiple instances of one or more of the components shown in the figure.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure. In addition, unless specifically stated otherwise, discussions utilizing terms such as “analyzing,” “determining,” “enabling,” “identifying,” “modifying” or the like, refer to the actions and processes of a computer system, or similar electronic computing device, that manipulates and transforms data represented as physical (e.g., electronic) quantities within the computer system's registers and memories into other data represented as physical quantities within the computer system memories or other such information storage, transmission or display devices.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

What is claimed is:

1. An apparatus, comprising:
one or more processors configured to:
obtain a medical image from a medical image repository;
obtain multiple textual descriptions associated with a set of image classification labels;
pair the medical image with one or more of the multiple text descriptions to obtain one or more corresponding image-text pairs;
classify the medical image based on a machine-learning (ML) model and the one or more image-text pairs, wherein the ML model is configured to predict respective similarities between the medical image and the corresponding text descriptions in the one or more image-text pairs, and wherein the one or more processors are configured to determine a class of the medical image by comparing the similarities predicted by the ML model; and
further process the medical image based on the class of the medical image.

2. The apparatus of claim 1, wherein the ML model includes a vision encoding portion and a text encoding portion, the vision encoding portion is configured to encode image features of the medical image, the text encoding portion is configured to encode respective text features of the multiple textual descriptions, and the ML model is configured to predict the respective similarity between the medical image and the corresponding text description in each of the one or more image-text pairs based on the image features of the medical image and the text features of the corresponding text description in each of the one or more image-text pairs.

3. The apparatus of claim 2, wherein the ML model is configured to align the image features of the medical image with the respective text features of the corresponding text description in each of the one or more image-text pairs in a common embedding space.

4. The apparatus of claim 1, wherein the one or more processors are configured to determine the class of the medical image based on an image-text pair of which the textual description is predicted by the ML model to be most similar to the medical image.

5. The apparatus of claim 4, wherein the text description of the image-text pair that is predicted by the ML model to be most similar to the medical image is generated based on one of the image classification labels, and wherein the one or more processors are configured to determine the class of the medical image based on the image classification label from which the text description is generated.

6. The apparatus of claim 1, wherein the set of image classification labels identifies multiple body parts, multiple imaging modalities, multiple image views, or multiple imaging protocols.

7. The apparatus of claim 1, wherein at least one of the textual descriptions includes a negation of an association between the medical image and one of the image classification labels.

8. The apparatus of claim 1, wherein the ML model is trained using a training dataset comprising multiple training image-text pairs, wherein each training image-text pair includes a training image and a training textual description, wherein the ML model is trained to learn a similarity or dissimilarity between the training image and the training textual description in each training image-text pair based on a contrastive learning technique, and wherein the class of the medical image is not present in the training dataset.

9. The apparatus of claim 1, wherein the one or more processors being configured to further process the medical image based on the class of the medical image comprises the one or more processors being configured to provide the medical image to a medical image processing application or module configured to process medical images of the class.

10. The apparatus of claim 1, wherein the multiple textual descriptions include a prompt to tag a structure in the medical image, and wherein the one or more processors being configured to classify the medical image based on the ML model and the one or more image-text pairs comprise the one or more processors being configured to tag the structure in the medical image using a vision-language ML model trained for matching features of the prompt with features of the structure in the medical image.

11. A method for sorting medical images, the method comprising:
obtaining a medical image from a medical image repository;
obtaining multiple textual descriptions associated with a set of image classification labels;
pairing the medical image with one or more of the multiple text descriptions to obtain one or more corresponding image-text pairs;
classifying the medical image based on a machine-learning (ML) model and the one or more image-text pairs, wherein the ML model is configured to predict a respective similarity between the medical image and the corresponding text description in each of the one or more image-text pairs, and wherein the one or more processors are configured to determine a class of the medical image by comparing the similarities predicted by the ML model; and
further processing the medical image based on the class of the medical image.

12. The method of claim 11, wherein the ML model includes a vision encoding portion and a text encoding portion, the vision encoding portion is configured to encode image features of the medical image, the text encoding portion is configured to encode respective text features of the multiple textual descriptions, and the ML model is configured to predict the respective similarity between the medical image and the corresponding text description in each of the one or more image-text pairs based on the image features of the medical image and the text features of the corresponding text description in each of the one or more image-text pairs.

13. The method of claim 12, wherein the ML model is further configured to align the image features of the medical image with the respective text features of the corresponding text description in each of the one or more image-text pairs in a common embedding space.

14. The method of claim 11, wherein the class of the medical image is determined based on an image-text pair of which the textual description is predicted by the ML model to be most similar to the medical image.

15. The method of claim 14, wherein the text description of the image-text pair that is predicted by the ML model to be most similar to the medical image is generated based on one of the image classification labels, and wherein the class of the medical image is determined based on the image classification label from which the text description is generated.

16. The method of claim 11, wherein the set of image classification labels identifies multiple body parts, multiple imaging modalities, multiple image views, or multiple imaging protocols.

17. The method of claim 11, wherein at least one of the textual descriptions includes a negation of an association between the medical image and one of the image classification labels.

18. The method of claim 11, wherein the ML model is trained using a training dataset comprising multiple training image-text pairs, wherein each training image-text pair includes a training image and a training textual description, wherein the ML model is trained to learn a similarity or dissimilarity between the training image and the training textual description in each training image-text pair based on a contrastive learning technique, and wherein the class of the medical image is not present in the training dataset.

19. The method of claim 11, wherein the multiple textual descriptions include a prompt to tag a structure in the medical image, and wherein classifying the medical image based on the ML model and the one or more image-text pairs comprise tagging the structure in the medical image using a vision-language ML model trained for matching features of the prompt with features of the structure in the medical image.

20. A non-transitory computer-readable medium comprising instructions that, when executed by a processor included in a computing device, cause the processor to implement the method of claim 11.
